(19) United States
(12) Patent Application Publication
(10) Pub. No.: US 2026/0356433 A1
(43) Pub. Date: Nov. 12, 2026

(54) High strength high slenderness part having excellent energy absorption and anti-intrusion properties

(71) Applicant: ArcelorMittal, Luxembourg (LU)

(72) Inventors: Clément PHILIPPOT, Ennery (FR); Arnaud COCU, Montataire (FR)

(21) Appl. No.: 19/125,057

(22) PCT Filed: Oct. 25, 2023
(86) PCT No.: PCT/IB2023/060759

§ 371 Date: Apr. 28, 2025

(30) Foreign Application Priority Data
Nov. 4, 2022 (WO) PCT/IB2022/060637

(51) Int. Cl. B62D 21/15

(52) U.S. Cl. CPC B62D 21/157

(57) ABSTRACT

A high slenderness structural part having excellent crash resistance and energy absorption both in bending and compressive mode and being made from materials having an ultimate tensile strength above 1300 MPa, a ratio between the Yield Strength YS and the ultimate tensile strength UTS of the materials strictly lower than 0.85, a bending angle above 70° and having a slenderness ratio equal to or greater than 10.

The present invention relates to a high strength structural part having excellent energy absorption properties in the case of a side impact and a longitudinal impact. In particular, the present invention relates to a structural part for use in an automotive vehicle.

### BACKGROUND

High strength high slenderness structural parts play an important role in the crash resistance of a vehicle. They are long and narrow assemblies comprising a hollow cavity.

In the case of a crash, such parts can be impacted on their side, i.e. in a direction generally transversal to the length direction, or can be impacted in a generally longitudinal direction.

### SUMMARY OF THE INVENTION

When impacted on its side, this type of structural part generally bends under the load of the impact. The bending behavior of the part plays a crucial role in the absorption of the energy of the impact and in resisting intrusion of the impactor into the vehicle. Good energy absorption and anti-intrusion is very important to minimize the consequences of the impact on the occupants of the vehicle and on the rest of the vehicle structure. In the case of an electric, hybrid or hydrogen fueled vehicle, anti-intrusion is also very important in guaranteeing the integrity of the battery pack and/or the hydrogen tank, which in turns plays an important role in guaranteeing the safety of the vehicle occupants.

As such, high strength high slenderness structural parts play a fundamental role in promoting the safety of the vehicle's occupants in the case of a side impact.

The resistance to side impacts of a vehicle is considered a major safety issue and is measured by several normalized tests such as for example:
the US New Car Assessment Program's (USNCAP) pole tests, in which a vehicle having an initial lateral speed of 32.2 km/h impacts on its side a fixed pole.
the IIHS's side moveable deformable barrier (MDB) test, in which a vehicle is impacted on its side by a deformable barrier having a weight of 1500 kg and travelling at a speed of 50 km/h.

These normalized tests are regularly updated to take into account even more severe crash conditions, for example by increasing the weight of the barrier, the speed of impact and the required criteria to pass the test.

When impacted longitudinally, the part is subjected to a compressive force. In order to absorb the maximum amount of energy it is important that the high slenderness part bottles onto itself as much as possible with a minimum occurrence of cracks.

Longitudinal impacts on front members for example, which are generally high slenderness parts, are simulated for example by the following normalized crash tests:
the Insurance Institute for Highway Safety's (IIHS) Small Overlap Rigid Barrier (SORB) crash, in which a vehicle is impacted with only 25% overlap in the width by a rigid barrier moving at 64.4 km/h; and
the IIHS's front overlap deformable barrier (ODB), in which a vehicle is impacted with only 40% overlap in the width by a rigid barrier moving at 64.4 km/h.

It is an object of the present invention to provide high strength high slenderness parts having excellent energy absorption and anti-intrusion behavior, both in configurations of transversal and longitudinal impacts.

The present invention provides a high slenderness part extending in a main longitudinal direction L between two ends, comprising a hollow volume encased between a top part and a bottom part made by hot stamping steel sheets separately and then joining together the top part, and the bottom part, said steel sheets having after hot stamping an ultimate tensile strength above 1300 MPa, having a Yield strength YS also expressed in MPa, having a length L, expressed in mm, an area of its straight section S, expressed in mm², and a minimum quadratic moment of area in said straight section Imin, expressed in mm⁴ wherein:
the ratio between the Yield Strength YS and the ultimate tensile strength UTS of the materials is strictly lower than 0.85,
the bending angle of the materials in the rolling direction normalized to a 1.5 mm thickness, is above 70°,
the slenderness ratio of the part, defined as slenderness ratio=L/√(Imin/S), is equal to or greater than 10,
said top part and said bottom part are joined together by spot welding and wherein the alpha cross-tensile strength resistance of the spot welds is above 70 kN/mm².

### BRIEF DESCRIPTION OF THE DRAWINGS

The invention will now be described in detail and illustrated by examples without introducing limitations, with reference to the appended figures:

FIG. 1 is a schematic view of a high slenderness part according to an embodiment of the present invention, with FIG. 1a being an insert detailing the definition of the different angles defined in the description.

FIG. 2 is a schematic view of the three-point bending test performed in examples 1 and 2 of the description below.

FIG. 3 is the graphic rendition at the end of the 3-point bending simulation of example 1 in the case of part I1w, which is according to an embodiment of the present invention.

FIG. 4 is the graphic rendition at the end of the 3-point bending simulation of example 2 in the case of part I1w, which is according to an embodiment of the present invention.

FIG. 5 is the graphic rendition at the end of the compression test simulation of example 3 in the case of part I1 (left of the figure), which is according to an embodiment of the present invention and of part R4 (right of the figure), which is not according to the present invention.

### DETAILED DESCRIPTION

The slenderness ratio, commonly used in Leonhard Euler's buckling theory, is defined by the following formula, where L is the length of the part, expressed in mm, S is the area of its straight section, expressed in mm², and Imin is the minimum quadratic moment of area in the section being considered.

$$Slenderness ratio = \frac{L}{\sqrt{\frac{Imin}{S}}}$$

In general, the minimum quadratic moment of area Imin, expressed in mm⁴ over a cross section A in a set of cartesian coordinates (x,y) is defined by the following formula:

Iminm=min(∫∫_{A}y²dxdy;∫∫_{A}x²dxdy)

For example, the minimum quadratic moment of area Imin for a hollow rectangular section having outer dimension b and h and inner dimensions b1 and h1 is calculated using the following formula:

$$Imin = min ( \frac{{bh}^{3} - b 1 h {1}^{3}}{12} ; \frac{{hb}^{3} - h 1 b {1}^{3}}{12} )$$

For example, the minimum quadratic moment of area Imin for a hollow annular section having outer radius R and inner radius R1 is calculated using the following formula:

$$Imin = \frac{π}{4} ( {R}^{4} - R {1}^{4} )$$

A part can be considered to have a high slenderness when its slenderness ratio is above 10, preferably when the slenderness ratio is above 15, even more preferably when the slenderness ratio is above 20.

The bending angle is measured according to the VDA-238-100 bending standard. In the current invention, the bending angles are measured after springback. For the same material, the bending angle depends on the thickness. For the sake of simplicity, the bending angle values of the current invention refer to a thickness of 1.5 mm. If the thickness is different than 1.5 mm, the bending angle value needs to be normalized to an equivalent 1.5 mm thickness by the following calculation where α_{1.5} is the bending angle normalized at 1.5 mm, t is the thickness, and at is the bending angle for thickness t:

α_{1.5}=(αₜ×t)/√1.5

The bending angle of a part is representative of the ability of the part to resist deformation without the formation of cracks.

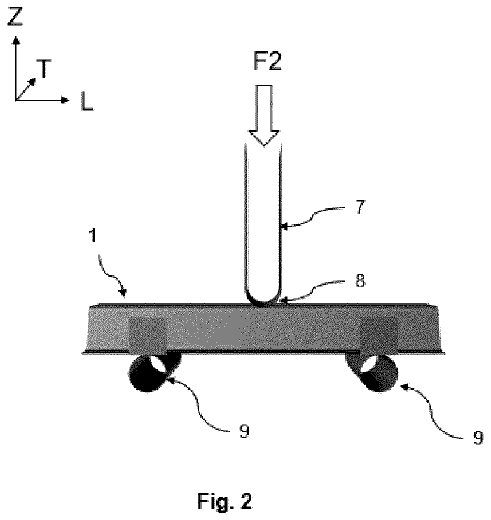

In the current invention, the bending angle was measured in the rolling direction, i.e. the direction along which the steel sheet travelled during the hot-rolling step. The bending angle was measured using a laser measurement device. When performing bending tests on hot stamped part, the samples are cut-out from flat areas of the part. If necessary, small size samples are taken to accommodate for the total available flat area on the part. If the rolling direction on the hot stamped part is not known, it can be determined using Electron Back-Scattered Diffraction (EBSD) analysis across the section of the sample in a Scanning Electron Microscope (SEM). The rolling direction is determined according to the intensity of the Orientation Density Function (ODF) representative of the major fibers at φ2=45°, where φ2 is the Euler angle as defined in “H.-J. Bunge: Texture Analysis in Materials Science—Mathematical Methods. 1st English Edition by Butterworth Co (Publ.) 1982” (see FIGS. 2.2 and 2.3 in Bunge for the definition of φ2).

The ultimate tensile strength, the yield strength and the elongation are measured according to ISO standard ISO 6892-1, published in October 2009. The tensile test specimens are cut-out from flat areas. If necessary, small size tensile test samples are taken to accommodate for the total available flat area on the part.

The term fracture strain refers to the fracture strain criterion defined by Pascal Dietsch et al. in “Methodology to assess fracture during crash simulation: fracture strain criteria and their calibration”, in Metallurgical Research Technology Volume 114, Number 6, 2017. The fracture strain is the equivalent strain within the material at the deformation point when the critical bending angle has been reached. The critical bending angle defines the angle at which the first cracks are detected on the extrados of a sample which has been deformed according to the standardized VDA-238-100 Standard.

The term “bottling” refers to the mode of deformation of a part subjected to a compressive load, typically a high slenderness part, where the part progressively absorbs the mechanical energy of the compressive load by forming a series of successive waves resulting from successive local buckling deformations. As a result, the length of the part as measured in the direction of the compressive load is smaller after the deformation than the initial length of the part in said direction. In other words, when a part reacts to a compressive load by controlled buckling, it folds onto itself in the same way as a plastic bottle on which a compressive load is applied between the top and the bottom of the bottle.

Hot stamping is a forming technology for steel which involves heating a blank up to a temperature at which the microstructure of the steel has at least partially transformed to austenite, forming the blank at high temperature by stamping it and quenching the formed part to obtain a microstructure having a very high strength, possibly with an additional partitioning or tempering step in the heat treatment. Hot stamping allows to obtain very high strength parts with complex shapes and presents many technical advantages. It should be understood that the thermal treatment to which a part is submitted includes not only the above-described thermal cycle of the hot stamping process itself, but also possibly other subsequent heat treatment cycles such as for example the paint baking step, performed after the part has been painted in order to bake the paint. The mechanical properties of hot stamped parts below are those measured after the full thermal cycle, including optionally for example a paint baking step, in case paint baking has indeed been performed—or any post tempering step.

A blank refers to a flat sheet, which has been cut to any shape suitable for its use. A blank has a top and bottom face, which are also referred to as a top and bottom side or as a top and bottom surface. The distance between said faces is designated as the thickness of the blank. The thickness can be measured, for example using a micrometer, the spindle and anvil of which are placed on the top and bottom faces. In a similar way, the thickness can also be measured on a formed part.

Hardness is a measure of resistance to localized plastic deformation induced by mechanical indentation. It is well correlated to the mechanical properties of a material and is a useful local measurement method which does not require to cut out a sample for tensile testing. In the current invention, the hardness measurements are made using a Vickers indenter according to standard ISO 6507-1. The Vickers hardness is expressed using the unit Hv.

The heat affected zone is the area of material surrounding a weld which has been heated up during the welding operation. In the case of high strength materials, for example high strength steels, it is well known that the heat affected zone can have weaker mechanical properties. Indeed, the heat affected zone undergoes a thermal treatment akin to tempering, which can lead to softening.

The cross tensile strength, also known as the alpha-CTS value for spot weld resistance reflects the strength of a spot weld in the case of a cross tensile type of loading and is expressed as the ratio of maximum cross tensile strength to the product of the weld nugget diameter by the average thickness of the steel sheets to be joined. When dividing the strength by the product of the average sheet metal thickness and the weld nugget diameter, it is possible to obtain a normalized value which will stay valid and applicable to a wide range of industrial weld assembly configurations. It is widely used in the sheet metal and the welding industry. The alpha-CTS value is obtained by the following protocol:
providing, according to ISO 14272 standard as published on Mar. 1, 2016, a cross welded assembly of two metal samples having thicknesses t1 and t2 and each measuring 100 mm*50 mm, the weld nugget having a diameter d,
measuring the cross tensile strength (CTS), expressed in kN, of said assembly according to ISO 14272 standard as published on Mar. 1, 2016, and
computing alpha-CTS expressed in kN/mm² as the ratio of said CTS expressed in kN to the product of the average thickness by the weld nugget diameter, each expressed in mm:

$$Alpha - CTS = \frac{CTS}{\frac{t 1 + t 2}{2} * d}$$

In the description, figures and claims, the orientations and spatial references are all made using an L, T, Z coordinates referential, wherein L is the longitudinal direction, parallel to the length direction of the part, i.e. to the longest dimension of the part, T is the transverse direction along which the part extends perpendicular to said longitudinal direction and Z is the elevation direction, perpendicular to the plane formed by the L and T directions. The referential is represented in each figure. When the figure is a 2D flat representation, the axis which is outside of the figure is represented by a dot in a circle when it is pointing towards the reader and by a cross in a circle when it is pointing away from the reader, following established conventions.

The directional terms “top”, “up”, “upper”, “above”, “bottom”, “low”, “lower”, “below” etc. are defined according to the Z elevation direction. The directional terms “front” and “back” are defined according to the L direction. The “width” or “transverse” direction refers to the orientation parallel to the T direction.

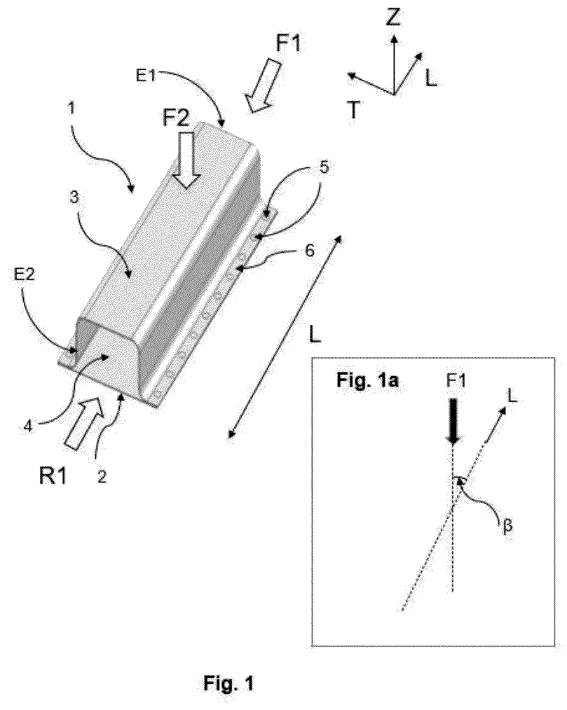

Referring to FIG. 1, a high slenderness part 1 extends in a main longitudinal direction L between two ends E1 and E2 and in a transverse direction T. It comprises a hollow volume 4 encased between a top part 3 and a bottom part 2.

The high slenderness part 1 is made by forming separately and then joining together the top part 3, and the bottom part 2. For example, the top part 3 and the bottom part 2 are joined together by welding, for example by spot welding on flanges 6, which produces spot welds 5.

In a particular embodiment, as depicted on FIG. 1, the top part 3, has a generally omega shape, and the bottom part 2 is a flat closing plate. In a particular embodiment, the top part 3, is generally omega shaped, and the bottom part 2 also has a generally omega shape (this is for example the case in the parts of example 2, which will be detailed further below).

High slenderness parts abound in vehicle architectures, some examples are the front parts joining the front crash boxes to the rocker assembly, the rear parts joining the rear crash boxes to the rocker assembly, cross members extending transversally in the vehicle, the rocker panels themselves etc. In the case of electric or hybrid vehicles, the battery pack is usually framed by a set of high slenderness parts designed to protect the battery cells in case of an impact.

A high slenderness part is generally attached to the rest of the vehicle structure at each of its ends E1 and E2. When the vehicle is involved in a crash, part of the energy of the crash can be transmitted to the high slenderness part by the parts to which it is attached. In this case, the high slenderness part will be submitted to a generally compressive load exerted between its ends E1 and E2 and resulting from a force F1, depicted on FIG. 1, transmitted by the surrounding elements to which the part is attached to, and a resulting resistive force R1 coming from the resistance of the other elements to which the part is attached to at its other end.

Said compressive force F1 will not necessarily be strictly parallel to the longitudinal direction and can form an angle β with the L axis, as depicted on FIG. 1a. As will be detailed later in the example, this situation corresponds to the compressive load testing and associated numerical simulation. In the rest of the description, it will be referred to as the compressive mode.

In the case of a crash, the impact force can also have at least a component directed following a direction perpendicular to the longitudinal direction, for example in the elevation direction. This is the case of force F2 represented on FIG. 2. In this case, the part will be submitted to a form of 3 points bending load, the force F2 being applied on one side and resistive forces in the opposite direction coming from the resistance of the other elements to which the part is attached to at both ends E1, E2. As will be detailed later in the examples, this situation corresponds to the 3-point bending test and associated numerical simulation. In the rest of the description, it will be referred to as the bending mode.

Whatever the load conditions, in order to provide effective protection in case of a crash, a high slenderness part needs to absorb a high amount of crash energy without significant occurrence of cracks. Indeed, by absorbing a high amount of crash energy the part will minimize the amount of energy which is transmitted to the rest of the vehicle structure and to its occupants. Moreover, it is important to prevent crack occurrence to preserve the vehicle structural integrity and to prevent intrusion into the vehicle passenger cell or into the battery cell compartment.

Because the direction in which an impact will occur in real life conditions cannot be predicted, it is important to absorb energy without significant crack occurrence both in the compressive mode and the bending mode. This will ensure a very robust behavior of the vehicle, whatever the crash conditions may be.

The inventors have found that by providing a part having a high slenderness ratio, for example above 10, preferably above 15, even more preferably above 20, made from materials having a tensile strength above 1300 MPa, preferably 1500 MPa, a bending angle in the longitudinal direction above 70° and a yield strength to tensile strength ratio strictly lower than 0.85, preferably below 0.82, even more preferably below 0.80, it was possible to absorb a high amount of energy while minimizing the occurrence of cracks both in compressive and bending mode.

By using a high tensile strength material, as detailed above, it is possible to absorb a high amount of energy because the deformation of the part resulting from the crash force necessitates a high amount of energy. However, the risk is that under the effect of the crash force the high slenderness part starts to crack and that cracks propagate in the part leading to failure of the part. In this case, the part is no longer structurally sound and stops being efficient in absorbing further energy and preventing intrusion. The inventors have found that this could be remedied by using materials which have a high bending angle. Indeed, the folds which are formed in the deformed areas will not lead to the occurrence of cracks as long as the deformation angles measured within these folds do not exceed the maximum bending angle of the materials made to form the part.

Furthermore, the inventors have found surprisingly that it was interesting to keep the yield strength to ultimate tensile strength ratio below a given maximum level. This could be due to the fact that lower ratios of yield strength to ultimate tensile strength lead to smoother shapes in the deformed areas thanks to the strain hardening properties of the material. In turn, smoother shapes mean larger bending radii in the deformed areas and therefore lower strain localization and a lower likelihood of crack occurrence.

The high slenderness part is made by spot welding a top part 3 and a bottom part 2. The inventors have further found that it was possible to provide a high slenderness part having the desired properties of high energy absorption and low crack occurrence in compression and bending mode by using materials having an alpha-CTS resistance above 70 kN/mm². Indeed, by using materials having such a high alpha-CTS resistance, it is possible to minimize the risk of the welds failing under the important load of the crash energy. Said weld failure generally leads to much less efficient performance of the part, which no longer works as a single high rigidity unit against the crash force.

In a particular embodiment, the material used to manufacture the entire high slenderness part is a steel sheet comprising the following elements expressed in weight %:
C: 0.15-0.25%
Mn:0.5-1.8%
Si: 0.1-1.25%
Al: 0.01-0.1%
Cr: 0.1-1.0%
Ti: 0.01-0.1%
B: 0.001-0.004%
P≤0.020%
S≤0.010%
N≤0.010%
and comprising optionally one or more of the following elements, by weight percent:
Mo≤0.40%
Nb≤0.08%
Ca≤0.1%
the remainder of the composition being iron and unavoidable impurities resulting from the smelting.

The remainder of the composition of the steel is iron and impurities resulting from the elaboration process. The level of impurities resulting from the elaboration process will depend on the production route used. For example, when using a Blast Furnace route with a low level of steel scrap (recycled steel), the level of impurities will remain very low. On the other hand, when elaborating the steel using an electric furnace, with a very high ratio of recycled scrap steel, the level of impurities will be significantly increased. In this latter case, for example, the level of Cu can go up to 0.25%, Ni can go up to 0.25%, Sn can go up to 0.05%, As can go up to 0.03%, Sb can go up to 0.03% and Pb can go up to 0.03%.

The invention will now be illustrated by the following examples, which are by no way limitative. The examples will compare the performance of a high slenderness part according to the invention with reference parts having the same geometry but different material properties. It will be shown that the parts according to the invention exhibit better energy absorption and less crack occurrence than the reference parts.

The behavior of the parts in compressive mode and in bending mode will be assessed.

The behavior of the parts was simulated using LS-DYNA R11.1.0. The mesh size used is 3 mm.

The behavior of the spot welds under load was simulated applying the method developed in the Fosta 806 project: “P 806—Characterization and simplified modeling of the fracture behavior of spot welds from ultra-high strength steels for crash simulation with consideration of the effects of the joints on component behavior” (Fosta stands for “Forschungsvereinigung Stahlanwendung”, i.e. The Research Association for Steel Application).

The failure behavior and associated deleted elements calculation is simulated using the material cards MAT123 and MAT_ADD_EROSION. Further explanation on the methodology can be found for example in “Simulation of Spot Welds and Weld Seams of Press-Hardened Steel (PHS) Assemblies”, Stanislaw Klimek, International Automotive Body Congress 2008.

As a general rule, the number of deleted elements is an evaluation of the amount of fracture that occurs during the crash. Because the failure modelling does not take into account the propagation of cracks, it can be said that the effect of fracture on the overall results is probably underestimated in the simulations and that in actual physical crash tests the energy absorption levels would probably be lower when the number of deleted elements is high because of failure propagation and eventual total failure of the part (such as for example the part being cut in two). It should be noted that such catastrophic failure is an issue for energy absorption but also for the overall behavior of the part in the predicted crash scenario of the vehicle.

Indeed, it disrupts the anticipated load path and means that the different parts of the vehicle will travel in uncontrolled directions because they are not anymore joined together. This lack of control leads to unpredictable and catastrophic behavior of the vehicle during a crash.

### Example 1

In a first example, referring to FIG. 1, the simulated high slenderness part 1 is made by forming separately and then joining together the top part 3, which is a generally omega shaped part, and the bottom part 2, which is a flat closing plate by spot welding on flanges 6, which produces spot welds 5. The joining is performed by 20 spot welds on each side every 30 mm along each flange. Each spot weld 5 has a 5.1 mm diameter nugget and the heat affected zone is simulated by a 3 mm ring around each nugget.

The high slenderness part 1 has the following dimensions:
omega shaped top part 3 having a sheet metal thickness of 1.5 mm before forming,
bottom part 2, a flat closing plate, having a sheet metal thickness of 1.0 mm before forming,
length L of 600 mm
closing plate 2 having a total width in the transverse direction of 130 mm, comprising two flanges 6 of 25 mm each. Hence the width of the closing plate enclosing the hollow volume 4 is 130-2*25=80 mm.
height of the hollow volume 4 of 60 mm.

Given the mesh size of 3 mm, the above-described part is composed of a total number of 24331 elements.

For simplicity's sake, the slenderness factor below was calculated for a perfectly rectangular part having the same hollow volume 4 and the same sheet metal thickness. That is to say, the slenderness factor is calculated without taking into account the contribution of the flanges, which will be very minimal.

In the formula below, the factors b1 and b correspond respectively to the inner width (i.e. 80 mm) and outer width (i.e. b=b1+2*(thickness of the top part)=b1+3 mm) of the rectangular part, the factors h1 and h correspond respectively to the inner height (i.e. 60 mm) and outer height (i.e. h=h1+(thickness of the top part)+(thickness of the bottom part)=h1+2.5 mm) of the rectangular part. The minimum quadratic moment is given by the formula:

$$Imin = min ( \frac{{bh}^{3} - b 1 h {1}^{3}}{12} ; \frac{{hb}^{3} - h 1 b {1}^{3}}{12} )$$

Which computes as:

$$Imin = min ( \frac{83 * 62 . {5}^{3} - 80 * 6 {0}^{3}}{12} ; \frac{62.5 * 8 {3}^{3} - 60 * 8 {0}^{3}}{12} )$$

$$Imin = min ( 418057.29 ; 248639.32 )$$

$$Imin = 24863 \; 9.32$$

The slenderness ratio is given by the following formula:

$$Slenderness ratio = \frac{L}{\sqrt{\frac{Imin}{S}}}$$

In which the area of the straight section S=h*b−h1*b1

Which computes as

$$Slenderness ratio = \frac{600}{\sqrt{\frac{248 639.32}{62.5 * 83 - 60 * 80}}}$$

$$Slenderness ratio = 23. 7$$

The described shape therefore has a slenderness ratio of 23.7.

Referring to FIG. 2, example 1 is a simulation of a 3-point bending test, which reflects the bending behavior of a part. The test conditions are as follows:
the part 1 is placed on two cylindrical support structures 9 each having a diameter of 50 mm, and
an impactor 7 weighing 370 kg and having a rounded punch head 8 with a diameter of 50 mm applies a force F2 and travels at an initial speed of 8 m/s.

In table 1 below, the results of the crash tests of a part I1 using a material according to the invention, is compared with that of 4 different parts R1-R4, which use materials with are not according to the invention. The material characteristics of R1-R4 which are outside of the invention are underlined. For each material, two sets of results are listed, corresponding to the simulation made with and without taking into account the behavior of the spot welds and heat affected zones during the test. Columns I1, R1, R2, R3 and R4 are results without taking into account the weld behavior, whereas columns I1w, R1w, R2w, R3w and R4w (w for “weld”), take into account the possible failure of the weld and the heat affected zone using the above defined methodology. The case in which the spot weld and heat affected zone behaviors are not taken into consideration correspond to a simplification of a welded assembly or to an assembly made from one piece only, for example by metal extrusion or tube forming.

The results are expressed in terms of total energy absorption and energy absorption before the onset of failure, both measured in kJ, as provided directly by simulation software. The moment in the test at which the first crack occurs is indicated as a ratio of the penetration level of the impactor when the first crack occurs to the maximum penetration of the impactor at the end of the test (referred to as “% crush” in the table).

The number of deleted elements is also indicated, as it gives a good indication of the level of fracture in the part resulting from the crash. The levels of absorbed energy before and after the onset of failure are detailed separately because it is generally considered that in a real-life collision, once cracks start to appear they are likely to spread throughout the part and greatly affect the performance of the part. As explained previously, crack propagation is not taken into account in the simulation software and it is therefore likely that the amount of energy absorbed after the onset of crash is overestimated by the simulation software compared to what would be obtained in an actual physical crash test.

In the columns taking into account the spot weld and heat affected zone behavior, further information is provided on the alpha-CTS value of the assembly as well as the simulation results in terms of the onset of failure (% crush when the first crack appears) and extent of failure (as reflected by the amount of deleted elements) both in the spot welds and in the heat affected zones.

TABLE 1
example 1 results

| | | inventive | | | | | | | | | |
|---|---|---|---|---|---|---|---|---|---|---|---|
| | | examples | | Reference examples | | | | | | | |
| | | I1 | I1w | R1 | R1w | R2 | R2w | R3 | R3w | R4 | R4w |
| | Slenderness | 23.7 | 23.7 | 23.7 | 23.7 | 23.7 | 23.7 | 23.7 | 23.7 | 23.7 | 23.7 |
| | ratio | | | | | | | | | | |
| Material | Yield Strength | 1112 | 1112 | 901 | 901 | 1120 | 1120 | 1366 | 1366 | 1413 | 1413 |
| Properties | YS (MPa) | | | | | | | | | | |
| | Ultimate | 1446 | 1446 | 1202 | 1202 | 1528 | 1528 | 1500 | 1500 | 1893 | 1893 |
| | Tensile | | | | | | | | | | |
| | Strength UTS | | | | | | | | | | |
| | (MPa) | | | | | | | | | | |
| | YS/UTS | 0.77 | 0.77 | 0.75 | 0.75 | 0.73 | 0.73 | 0.91 | 0.91 | 0.75 | 0.75 |
| | bending angle | 80° | 80° | 80° | 80° | 47° | 47° | 52° | 52 | 52° | 52° |
| | Alpha CTS | — | 86 | — | 93 | — | 66 | — | 58 | — | 45 |
| | (kN/mm²) | | | | | | | | | | |
| Results | Total energy | 8.7 | 8.7 | 7.7 | 7.7 | 8.9 | 8.9 | 8.9 | 8.8 | 8.3 | 8.2 |
| | absorption (kJ) | | | | | | | | | | |
| | Energy | 8.7 | 8.7 | 7.6 | 7.6 | 3.2 | 3.2 | 3.1 | 3.1 | 1.9 | 1.9 |
| | absorption | | | | | | | | | | |
| | before failure | | | | | | | | | | |
| | onset (kJ) | | | | | | | | | | |
| | Onset of base | — | — | 98% | 98% | 48% | 48% | 45% | 45% | 27% | 26% |
| | metal failure | | | | | | | | | | |
| | (% Crush) | | | | | | | | | | |
| | Number of | 0 | 0 | 8 | 8 | 21 | 22 | 28 | 28 | 200 | 155 |
| | deleted | | | | | | | | | | |
| | elements | | | | | | | | | | |
| | Onset of HAZ | — | — | — | — | — | — | — | — | — | — |
| | failure | | | | | | | | | | |
| | (% Crush) | | | | | | | | | | |
| | Number HAZ | — | 0 | — | 0 | — | 0 | — | 0 | — | 0 |
| | deleted | | | | | | | | | | |
| | elements | | | | | | | | | | |
| | Onset of Spot | — | — | — | — | — | 59% | — | 56% | — | 54% |
| | weld failure | | | | | | | | | | |
| | (% Crush) | | | | | | | | | | |
| | Number of Spot | — | 0 | — | 0 | — | 10 | — | 26 | — | 22 |
| | weld deleted | | | | | | | | | | |
| | elements | | | | | | | | | | |

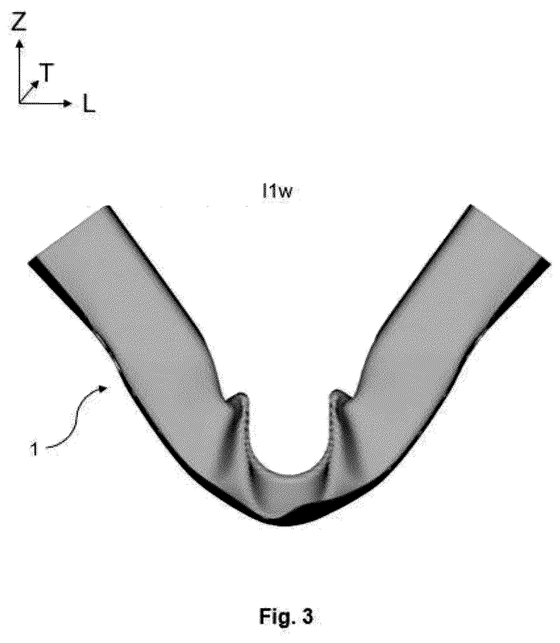

FIG. 3 is a graphic rendition at the end of the test in the case of part I1w, showing the total deformation of the part once the punch has run its course.

Remarkably, the part made with the material according to the invention shows no failure both with and without taking into account the welds. In the no-weld scenario, the total amount of absorbed energy is just under that of R2 and R3. However, the parts made with R2 and R3 start to crack at respectively 59% and 56% of punch penetration, that is, just over half way through the test. If crack propagation was taken into account, it is likely that the total amount of absorbed energy of R2 and R3 would drop. In any case, it would be much safer to choose part I1 as a safety part submitted to a transversal bending load as it will absorb a very high amount of energy and will be significantly less liable to fail due to crack propagation under load. This reasoning holds with and without taking into account the behavior of the spot welds and heat affected zones. The absence of a crack is also a key point in guaranteeing the anti-intrusion behavior of the part.

### Example 2

The high slenderness part of example 2 is a double omega shaped part, meaning that both the top part 3 and the bottom part 2 have an omega shape. They are joined by spot welding them to each other using spot welds 5 applied on flanges 6. As for the two previous examples, the joining is performed by 20 spot welds on each side every 30 mm along each flange. Each spot weld 5 has a 6.1 mm diameter nugget and the heat affected zone is simulated by a 3 mm ring around each nugget.

The geometry of the part is as follows:
omega shaped top part 3 and bottom part 2 having a sheet metal thickness of 1.5 mm before forming,
length L of 600 mm
bottom part 2 having a total width in the transverse direction of 130 mm, comprising two flanges 6 of 25 mm each. Hence the width of the closing plate enclosing the hollow volume 4 is 130-2*25=80 mm.
height of the hollow volume 4 of 120 mm

Given the mesh size of 3 mm, the above-described part is composed of a total number of 25650 elements.

As for the part of example 1, the slenderness factor is calculated without taking into account the contribution of the flanges, which will be very minimal.

In the formula below, the factors b1 and b correspond respectively to the inner width (i.e. 80 mm) and outer width (i.e. b=b1+2*(thickness of the top part)=b1+3 mm) of the rectangular part, the factors h1 and h correspond respectively to the inner height (i.e. 60 mm) and outer height (i.e. h=h1+(thickness of the top part)+(thickness of the bottom part)=h1+3 mm) of the rectangular part. The minimum quadratic moment is given by the formula:

$$Imin = min ( \frac{{bh}^{3} - b 1 h {1}^{3}}{12} ; \frac{{hb}^{3} - h 1 b {1}^{3}}{12} )$$

Which computes as:

$$Imin = min ( \frac{83 * 12 {3}^{3} - 80 * 12 {0}^{3}}{12} ; \frac{123 * 8 {3}^{3} - 120 * 8 {0}^{3}}{12} )$$

$$Imin = min ( 1350996.0 75 ; 740816.75 )$$

$$Imin = 740816.75$$

The slenderness ratio is given by the following formula:

$$Slenderness ratio = \frac{L}{\sqrt{\frac{Imin}{S}}}$$

In which the area of the straight section S=h*b−h1*b1

Which computes as

$$Slenderness ratio = \frac{600}{\sqrt{\frac{740 816.75}{123 * 83 - 120 * 80}}}$$

$$Slenderness ratio = 17. 2$$

The double omega part of example 2 therefore has a slenderness ratio of 17.2.

TABLE 2
Example 2 results

| | | inventive | | | | | | | | | |
|---|---|---|---|---|---|---|---|---|---|---|---|
| | | examples | | Reference examples | | | | | | | |
| | | I1 | I1w | R1 | R1w | R2 | R2w | R3 | R3w | R4 | R4w |
| | Slenderness | 17.2 | 17.2 | 17.2 | 17.2 | 17.2 | 17.2 | 17.2 | 17.2 | 17.2 | 17.2 |
| | ratio | | | | | | | | | | |
| Material | Yield Strength | 1112 | 1112 | 901 | 901 | 1120 | 1120 | 1366 | 1366 | 1413 | 1413 |
| Properties | YS (MPa) | | | | | | | | | | |
| | Ultimate | 1446 | 1446 | 1202 | 1202 | 1528 | 1528 | 1500 | 1500 | 1893 | 1893 |
| | Tensile | | | | | | | | | | |
| | Strength UTS | | | | | | | | | | |
| | (MPa) | | | | | | | | | | |
| | YS/UTS | 0.77 | 0.77 | 0.75 | 0.75 | 0.73 | 0.73 | 0.91 | 0.91 | 0.75 | 0.75 |
| | bending angle | 80° | 80° | 80° | 80° | 47° | 47° | 52° | 52° | 52° | 52° |
| | Alpha CTS | — | 86 | — | 93 | — | 66 | — | 58 | — | 45 |
| | (kN/mm²) | | | | | | | | | | |
| Results | Total energy | 7.5 | 7.1 | 6.6 | 6.4 | 7.6 | 6.4 | 7.8 | 6.3 | 7.4 | 4.0 |
| | absorption (kJ) | | | | | | | | | | |
| | Energy | 7.5 | 5.4 | 6.6 | 4.7 | 7.6 | 4.7 | 7.8 | 4.3 | 3.1 | 1.4 |
| | absorption | | | | | | | | | | |
| | before failure | | | | | | | | | | |
| | onset (kJ) | | | | | | | | | | |
| | Onset of base | — | — | — | — | — | — | — | — | 41% | 33% |
| | metal failure | | | | | | | | | | |
| | (% Crush) | | | | | | | | | | |
| | Number of | 0 | 0 | 0 | 0 | 0 | 0 | 0 | 0 | 112 | 102 |
| | base metal | | | | | | | | | | |
| | deleted | | | | | | | | | | |
| | elements | | | | | | | | | | |
| | Onset of HAZ | — | — | — | — | — | — | — | — | — | 72% |
| | failure | | | | | | | | | | |
| | (% Crush) | | | | | | | | | | |
| | Number HAZ | — | 0 | — | 0 | — | 0 | — | 0 | — | 10 |
| | deleted | | | | | | | | | | |
| | elements | | | | | | | | | | |
| | Onset of Spot | — | 70% | — | 69% | — | 64% | — | 55% | — | 22% |
| | weld failure | | | | | | | | | | |
| | (% Crush) | | | | | | | | | | |
| | Number of Spot | — | 10 | — | 9 | — | 12 | — | 14 | — | 14 |
| | weld deleted | | | | | | | | | | |
| | elements | | | | | | | | | | |

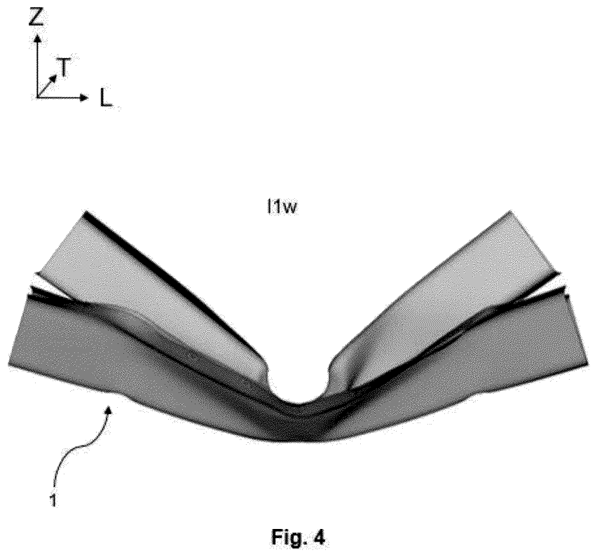

FIG. 4 is a graphic rendition at the end of the test in the case of part I1w, showing the total deformation of the part once the punch has run its course.

As in the first example, I1 does not crack under the bending load and while it has a slightly lower energy absorption level than R2 and R3 in the no-weld scenario, the fact that it does not crack at any point makes I1 the material of choice for a robust safe and reliable safety part.

On the other hand, when the behavior of the welds is taken into account, I1w has superior performances in energy absorption than all comparative examples.

### Example 3

In a third example, the simulated high slenderness part 1 has the same geometrical characteristics as in the first example (a simple omega shape with a closing plate). On the other hand, the diameter of the weld nuggets is 8.1 mm, instead of 5.1 mm in example 1. The heat affected zone is simulated by a 3 mm ring around each nugget.

This time, the part is impacted longitudinally, simulating a compression test. The part 1 is fixed at one end and impacted at its other end by a flat impactor 10 travelling at an angle β of 10° with the longitudinal direction and having an initial impact velocity of 16 m/s and a mass of 417 kg. FIG. 4 is a graphic representation of the end of the simulation of the compression test of examples 3 on the part I1 made with the inventive material and R4 made with a reference material.

TABLE 3
Example 3 results

| | | inventive | | | | | | | | | |
|---|---|---|---|---|---|---|---|---|---|---|---|
| | | examples | | Reference examples | | | | | | | |
| | | I1 | I1w | R1 | R1w | R2 | R2w | R3 | R3w | R4 | R4w |
| | Slenderness | 23.7 | 23.7 | 23.7 | 23.7 | 23.7 | 23.7 | 23.7 | 23.7 | 23.7 | 23.7 |
| | ratio | | | | | | | | | | |
| Material | Yield Strength | 1112 | 1112 | 901 | 901 | 1120 | 1120 | 1366 | 1366 | 1413 | 1413 |
| Properties | YS (MPa) | | | | | | | | | | |
| | Ultimate | 1446 | 1446 | 1202 | 1202 | 1528 | 1528 | 1500 | 1500 | 1893 | 1893 |
| | Tensile | | | | | | | | | | |
| | Strength UTS | | | | | | | | | | |
| | (MPa) | | | | | | | | | | |
| | YS/UTS | 0.77 | 0.77 | 0.75 | 0.75 | 0.73 | 0.73 | 0.91 | 0.91 | 0.75 | 0.75 |
| | bending angle | 80° | 80° | 80° | 80° | 47° | 47° | 52° | 52° | 52° | 52° |
| | Alpha CTS | — | 86 | — | 93 | — | 66 | — | 58 | — | 45 |
| | (kN/mm²) | | | | | | | | | | |
| Results | Total energy | 22.2 | 20.6 | 18.3 | 17.7 | 20.8 | 19.1 | 21.3 | 18.2 | 19.9 | 11.3 |
| | absorption (kJ) | | | | | | | | | | |
| | Number of | 64 | 13 | 46 | 22 | 300 | 218 | 268 | 242 | 763 | 305 |
| | base metal | | | | | | | | | | |
| | deleted | | | | | | | | | | |
| | elements | | | | | | | | | | |
| | Number HAZ | — | 28 | — | 35 | — | 26 | — | 15 | — | 6 |
| | deleted | | | | | | | | | | |
| | elements | | | | | | | | | | |
| | Number of Spot | — | 5 | — | 4 | — | 11 | — | 10 | — | 16 |
| | weld deleted | | | | | | | | | | |
| | elements | | | | | | | | | | |
| | Total number of | 64 | 46 | 46 | 61 | 300 | 255 | 268 | 267 | 763 | 327 |
| | deleted | | | | | | | | | | |
| | elements | | | | | | | | | | |

Looking at the comparative energy absorption and failure rate of parts impacted transversally with a 10° angle made with a material according to an embodiment of the invention, it appears to yield superior results to all the reference materials. In particular, the amount of absorbed energy is significantly higher with and without taking into account the behavior of the welds.

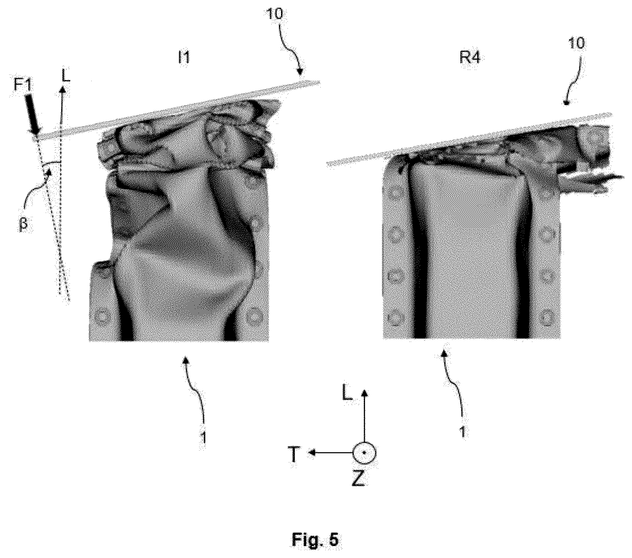

Referring to FIG. 5, it can be seen that part I1 absorbs a high amount of energy by bottling (as seen by the folds that form on the impacted end of the part).

On the other hand, part R4 absorbs less impact energy despite its significantly higher tensile strength because of the high amount of crack formation.

As a conclusion of these three examples, the parts made according to an embodiment of the present invention behave better in bending and compressive mode than comparative parts. They are therefore most suitable for high slenderness structural parts in vehicle architectures.

What is claimed is:

1-5. (canceled)

6: A high slenderness part extending in a main longitudinal direction L between two ends, the high slenderness part comprising:
a hollow volume encased between a top part and a bottom part made by hot stamping steel sheets separately and then joining together the top part and the bottom part, the steel sheets having after the hot stamping an ultimate tensile strength UTS above 1300 MPa, having a Yield strength YS also expressed in MPa, having a length L, expressed in mm, an area of a straight section, expressed in mm², and a minimum quadratic moment of area in the straight section Imin, expressed in mm⁴ wherein:
a ratio between the Yield Strength YS and the ultimate tensile strength UTS is strictly lower than 0.85,
a bending angle in a rolling direction normalized to a 1.5 mm thickness, is above 70°,
a slenderness ratio of the part, defined as slenderness ratio=L/N(Imin/S), is equal to or greater than 10, and
the top part and the bottom part are joined together by spot welding, wherein an alpha cross-tensile strength resistance of the spot welds is above 70 kN/mm².

7: The high slenderness part according to claim 6 wherein the ratio between the Yield Strength YS and the ultimate tensile strength UTS of the steel sheets after hot stamping is strictly lower than 0.82.

8: The high slenderness part according to claim 6 wherein the ratio between the Yield Strength YS and the ultimate tensile strength UTS of the steel sheets after hot stamping is strictly lower than 0.80.

9: The high slenderness part according to claim 6 wherein the slenderness ratio is equal to or greater than 15.

10: The high slenderness part according to claim 6 wherein the slenderness ratio is equal to or greater than 20.
